(19) United States
(12) Patent Application Publication
(10) Pub. No.: US 2012/0176620 A1
(43) Pub. Date: Jul. 12, 2012

(54) Method for Using a Variable Depletion Region to Determine a Range of the Electromagnetic Spectrum

(75) Inventor: David Ludwig, Irvine, CA (US)

(73) Assignee: Irvine Sensors Corporation, Costa Mesa, CA (US)

(21) Appl. No.: 13/346,918

(22) Filed: Jan. 10, 2012

Related U.S. Application Data
(60) Provisional application No. 61/460,846, filed on Jan. 10, 2011.

(51) Int. Cl. G01J 3/28

(52) U.S. Cl. 356/402

(57) ABSTRACT

A method for using a depletion region in a solid state spectrometer unit cell or plurality of cells for sensing different wavelengths of electromagnetic radiation at different depths within the substrate of the device. Variable bias voltages on one or more p-n junctions in the device are used so that the depth of the depletion regions are selectively varied. By varying the depletion region thickness of the p-n junctions in the device, the wavelengths absorbed by the semiconductor device and resultant electron-hole pairs collected by the p-n junctions are varied. In one embodiment, the outputs of each of two unit cell p-n junctions are sensed and the difference calculated and output to suitable circuitry for display as representative of a particular range or frequency of the electromagnetic spectrum.

### CROSS-REFERENCE TO RELATED APPLICATIONS

This application claims the benefit of U.S. Provisional Patent Application Ser. No. 61/460,846, filed on Jan. 10, 2011 entitled “Unit Cell Spectrometer pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of spectrometry. More specifically, the invention relates to a solid state depletion region unit cell spectrometer having no moving parts for use in the visible range of the electromagnetic spectrum and a method for using a variable depletion region to determine a range of the electromagnetic spectrum.

2. Description of the Related Art

Spectrometer devices have wide application and are used for the identification of a material or element based on electromagnetic spectra emitted or received from it. The spectra data from an element can be used, for instance, to identify the atomic makeup of the material, much like the unique fingerprint of an individual.

A conventional prior art spectrometer such as is depicted in FIG. 1 generally comprises) an electromagnetic radiation source (i.e., a light source) which may comprise electromagnetic radiation emitted as the result of heating the material under analysis, 2) a dispersal element which may comprise a moveable optical grating or slit for dispersing the received light into a plurality of individual spectral bands or lines and, 3) a detector element for detecting the intensity of the various received individual spectra. Based on the pattern and intensity of the various spectra that arc detected, the detector outputs can be compared to known materials or elements in order to identify the material under analysis.

Unfortunately, prior art spectrometer devices are fragile and expensive and, because they contain moving parts, are prone to environmental and handling stresses that can result in poor performance and breakage.

What is needed is a low cost spectrometer that is not subject to the deficiencies of prior art spectrometers having moving grating elements or other mechanical parts.

### BRIEF SUMMARY OF THE INVENTION

The invention comprises a solid state spectrometer unit cell or plurality of cells that takes advantage of a unique property of semiconductor materials such as silicon; that is the ability to absorb and generate electron-hole pairs at different wavelengths of electromagnetic radiation at different depths within the material such as silicon, germanium, gallium arsenide and other known doped semiconductor materials.

By separately varying a bias voltage on one or more p-n junctions in the device of the invention, the depth or thickness of the depletion region or regions may be selectively varied. For instance, a small bias voltage will generate a small depletion region at the p-n junction and a large bias will generate a large depletion region.

By varying the depletion region thickness at a single p-n junction or by separately varying the thicknesses of the depletion zones in a plurality of p-n junctions in the device, the wavelengths absorbed by the materials and the related electron-hole pairs that are collected by the p-n junctions can be controlled. In other words, by varying the thickness of the depletion region and its distance from the input surface, the device variably defines an electromagnetic wavelength “capture zone” which depth or thickness is directly related to that particular wavelength's penetration of the semiconductor material.

In an embodiment comprising a plurality of p-n junctions in the unit cell of the invention, the outputs of each of two unit cell p-n junctions are sensed and the difference between them calculated and output to suitable circuitry. In this manner, only the electron-hole pairs from the wavelength collected by one p-n junction and not the other is reported to the output circuit which is then processed and displayed as representative of a particular range or frequency of the electromagnetic spectrum. In this manner, the invention operates much like a broad-band detector in the fan of a prism.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts the major elements of a prior art spectrometer device.

FIG. 2 depicts a unit cell spectrometer of the invention showing a first depletion region and a second depletion region during a first time sample and a second time sample respectively.

FIG. 3 depicts a unit cell spectrometer of the invention comprising a first p-n junction and a second p-n junction each having a different bias voltage applied to define different respective depletion region depths.

FIGS. 3a and 3b depict different anode/cathode configurations for the unit cell spectrometer of the invention.

FIG. 4 illustrates a preferred set of process steps of the invention for use in determining a range of the electromagnetic spectrum.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

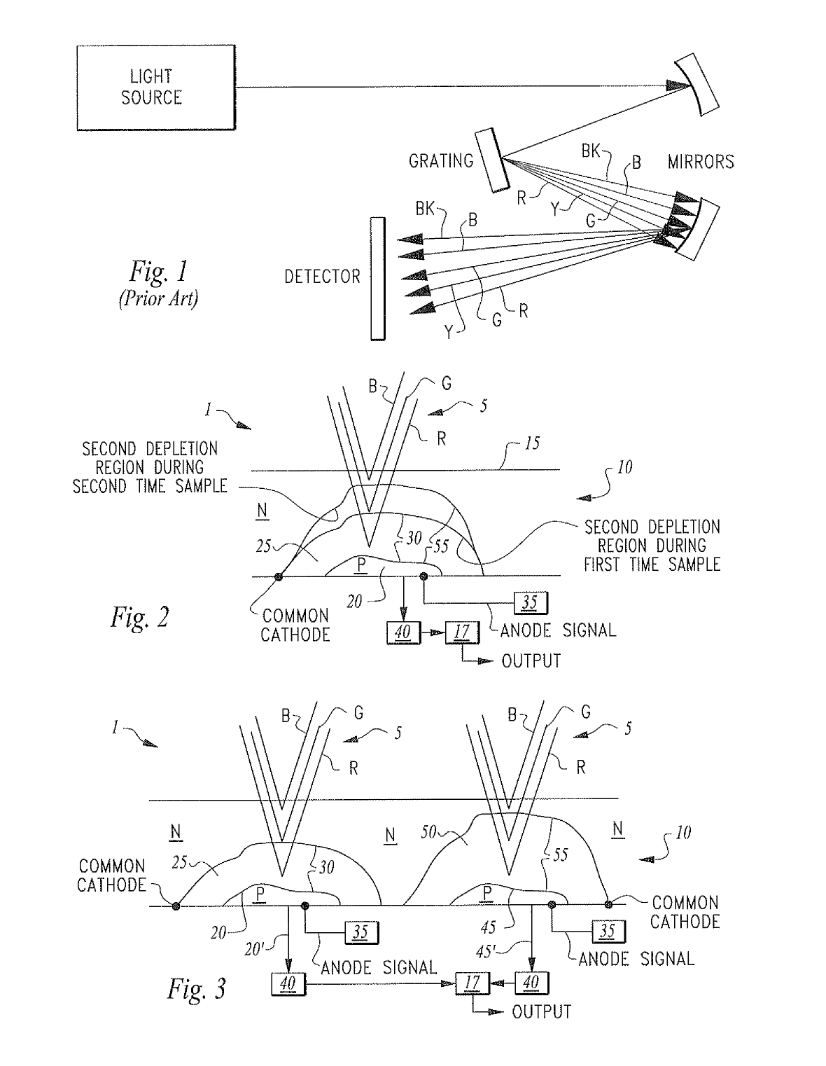

Turning now to FIGS. 2, 3, 3a, 3b and 4 wherein like numerals define like elements among the several views, a solid state unit cell spectrometer is disclosed.

The invention comprises a solid state spectrometer that takes advantage of the fact that semiconductor materials such as silicon generate electron-hole pairs at different wavelengths of the electromagnetic spectrum at different depths of penetration within the semiconductor material.

By using variable electrical bias means to vary the depth or thickness of one or more depletion regions at a p-n junction, the invention collects the resultant electron-hole pairs before they recombine to generate an output signal and provides a spectrometer that is both tunable to detect any visible wavelength as well as providing a tunable spectral bandwidth of capture.

In a first aspect of the invention, a unit cell spectrometer 1 for generating an electrical output signal in response to an incident electromagnetic radiation input signal 5 is disclosed comprising a semiconductor substrate 10 which may be a silicon material.

Unit cell spectrometer 1 comprises an input surface 15, a first p-n junction 20 and a first depletion region 25 having a variable first depth 30, a variable electrical bias means 35 electrically coupled to the substrate for varying the depth of the first depletion region 25 and output sensing means 40 for sensing a first p-n junction output signal 20′ from first p-n junction 20 in response to incident electromagnetic radiation input signal 5 on input surface 15.

In a second aspect of the invention, semiconductor substrate 10 of the unit cell spectrometer 1 has a thickness of less than about 25 microns.

In a third aspect of the invention, semiconductor substrate 10 of the unit cell spectrometer 1 has a thickness of greater than about 5 microns.

In a fourth aspect of the invention, semiconductor substrate 10 comprises a doped silicon material.

In a fifth aspect of the invention, a unit cell spectrometer 1 is disclosed comprising a semiconductor substrate 10 comprising an input surface 15, a first p-n junction 20, a first depletion region 25 having a variable first depth 30, a second p-n junction 45 and a second depletion region 50 having a variable second depth 55, variable electrical bias means 35 electrically coupled to the substrate 10 for separately varying the first depth 30 of the first depletion region 25 to a predetermined first depth and for separately varying the second depth 55 of the second depletion region 50 to a predetermined second depth, output sensing means 40 for sensing a first p-n junction output signal 20′ and for sensing a second p-n junction output signal 45′in response to an incident electromagnetic radiation input signal 5 on input surface 15 and circuit means 17 for determining and outputting a difference between the first p-n junction output signal 20′ and the second p-n junction output signal 45′ as representative of a range of the electromagnetic spectrum.

In a sixth aspect of the invention, semiconductor substrate 10 of the unit cell spectrometer 1 has a thickness of less than about 25 microns.

In a seventh aspect of the invention, semiconductor substrate 10 of the unit cell spectrometer 1 has a thickness of greater than about 5 microns.

In an eighth aspect of the invention, semiconductor substrate 10 of the unit cell spectrometer 1 comprises a doped silicon material.

In a ninth aspect of the invention, a method for generating an electrical output signal in response to an incident electromagnetic radiation input signal 5 is disclosed comprising the steps of providing a silicon substrate 10 having an input surface 15, a first p-n junction 20, a first depletion region 25 having a variable first depth 30, a second p-n junction 45 and a second depletion region 50 having a variable second depth 55, separately varying the first depth 30 of the first depletion region 25 to a predetermined first depth and varying the second depth 55 of the second depletion region 50 to a predetermined second depth, receiving an incident electromagnetic radiation input signal 5 on the input surface 15, sensing a first p-n junction output electrical signal 20′ and sensing a second p-n junction output electrical signal 45′ generated in response to the incident electromagnetic radiation signal 5, determining a difference between the first p-n junction output signal 20′ and the second p-n junction Output signal 45′ and outputting the difference as representative of a range of the electromagnetic spectrum. In a tenth aspect of the invention, semiconductor substrate 10 of the unit cell spectrometer 1 of the method has a thickness of less than about 25 microns.

In an eleventh aspect of the invention, semiconductor substrate 10 of the unit cell spectrometer 1 of the method has a thickness of greater than about 5 microns.

In a twelfth aspect of the invention, semiconductor substrate 10 of the unit spectrometer 1 of the method is comprised of a doped silicon material.

In a thirteenth aspect of the invention, a method for generating an electrical output signal in response to an incident electromagnetic radiation input signal 5 is disclosed comprising the steps of providing a semiconductor substrate 10 comprising an input surface 15, a first p-n junction 20 and a first depletion region 25 having a variable first depth 30, varying the first depth 30 using a first bias voltage during a first time sample, sensing a first time sample output signal from the first p-n junction 20 in response to an incident electromagnetic radiation input signal 5 on the input surface 15, varying the first depth 30 to a second depth 55 using a second bias voltage during a second time sample, sensing a second time sample output signal from the first p-n junction 20 in response to an incident electromagnetic radiation input signal 5 on the input surface 15, determining a difference between the first time sample output signal and the second time sample output signal and outputting the difference between the first time sample output signal and the second time sample output signal as representative of a range of the electromagnetic spectrum.

In prior art back-side illuminated photocells, the active detector areas are typically biased so as to be fully depleted so that all wavelengths of electromagnetic radiation incident on the input surface are detected, i.e. a bias voltage is applied such that the depletion region effectively reaches the input surface such that when a photon strikes the surface and generates an electron-hole pair, it is swept into the p-n junction and detected regardless of the depth of penetration in the substrate material. The invention herein does not fully deplete the detector substrate, rather it provides and takes advantage of a variable depth depletion region.

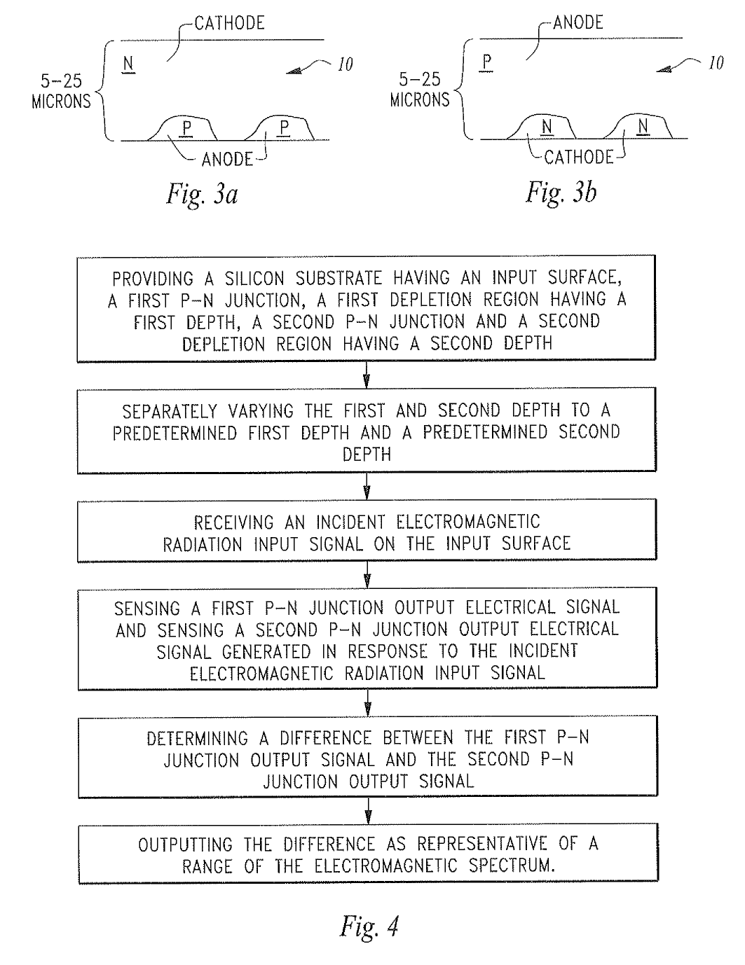

In the illustrated embodiment of FIGS. 2 and 3, a back-side illuminated unit cell of the invention is depicted but the invention is not limited to the illustrated configuration and may be provided as a front-side illuminated unit cell as is well-known in the semiconductor and photo-detector arts.

It is further noted that while the illustrated embodiments of FIGS. 2, 3 and 3a depict a representative anode/cathode configuration, the invention is not limited to such a configuration and the anode/cathode configuration of the invention may be provided as illustrated in both FIGS. 3a and 3b as is well-known in the semiconductor arts.

The invention takes advantage of the property of semiconductor materials whereby different wavelengths of electromagnetic radiation penetrate the semiconductor material to different depths. Depending on the depth of penetration into the semiconductor substrate and the depth of the depletion region, the wavelength of light generates electron-hole pairs which are either swept up by the p-n junction in the form of a p-n junction output signal or the pairs recombine and result in no output signal.

In the operation of the invention, electromagnetic radiation in the form of photons from an electromagnetic radiation source are incident on the input surface 15 opposite the one or more p-n junctions. The depth of the depletion region or regions on the substrate of the device, here illustrated as a silicon substrate, is user-definable by varying an applied bias voltage to the anode or cathode using variable electrical bias mean 35 with respect to the one or more pan junctions. A small bias voltage will generate a small depletion region and a large bias will generate a larger depletion region to an upper limit where the semiconductor is fully depleted.

In order to have the ability to fully deplete the semiconductor substrate using reasonable bias voltages, a silicon substrate 10 is preferably thinned to about 5-25 microns in thickness.

With respect to FIG. 2, the invention may be provided with a single p-n junction per unit cell. The operation of the single p-n junction embodiment has at least two input samples taken during different time samples using different bias voltages that are applied to the single p-n junction during each time sample (i.e., a different depletion region thickness is defined in each time sample).

In this manner of operation, if the two different bias voltages are relatively close together, the spectral bandwidth that represents the difference in signal is narrow. The narrow bandwidth may be positioned anywhere from blue to red in the visible electromagnetic spectrum.

If the difference in biases are relatively wide, then the spectral bandwidth represented by the difference in p-n junction output signals during each time sample will be wide.

In the embodiment of FIG. 2, a first bias voltage is applied by variable bias means 35 during a first time sample to define a first depletion region depth, which first p-n junction output signal defines a first time sample output signal that is output and stored using suitable external circuitry.

A second bias voltage is applied by variable bias means 35 during a second time sample to define a second depletion region depth which first p-n junction output signal defines a second time sample output signal that is output and stored using suitable external circuitry.

The difference between the p-n junction output signals from the first and second time samples is computed using external circuit means 17, the difference being an output signal representative of a range of the electromagnetic spectrum.

If two or more p-n junctions are provided in a unit cell as in FIGS. 3, 3a and 3b, the respective p-n junctions are preferably provided with the ability to separately vary the respective bias voltages. In this manner the wavelengths that are “collected” at differing depths within the substrate material by the respective p-n junctions can be defined by the user.

In the embodiment of FIG. 3, the two separate unit cell p-n junction output signals from an incident electromagnetic radiation input signal 5 are subtracted from each other, the difference representative of only the wavelength collected by one p-n junction and not the other, which difference is then is reported to suitable output circuitry 17 for further processing and display.

With respect to the representative operation of the embodiment of FIG. 3, first depletion region 25 of the first p-n junction 20 is varied to a thickness or depth so as to capture wavelengths in the visible red region of the electromagnetic spectrum.

The second depletion region 50 from the second p-n junction 45 captures both red and green light from the incident electromagnetic radiation input signal 5; the difference between the respective p-n junction output signals being output as representative of visible green light in the electromagnetic spectrum.

FIG. 4 reflects the preferred process steps of the invention as a method for generating an electrical output signal in response to an incident electromagnetic radiation input signal such as may be used to determine the nature of emitted electromagnetic radiation from a source.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A method for generating an electrical output signal in response to an incident electromagnetic radiation input signal comprising the steps of:
providing a silicon substrate having an input surface, a first p-n junction, a first depletion region having a variable first depth, a second p-n junction and a second depletion region having a variable second depth,
separately varying the first depth to a first predetermined depth and varying the second depth to a second predetermined depth,
receiving an incident electromagnetic radiation input signal on the input surface,
sensing a first p-n junction output electrical signal and sensing a second p-n junction output electrical signal generated in response to the incident electromagnetic radiation signal,
determining a difference between the first p-n junction output signal and the second p-n junction output signal, and,
outputting the difference as representative of a range of the electromagnetic spectrum.

2. The method of claim 1 wherein the semiconductor substrate has a thickness of less than about 25 microns.

3. The method of claim 1 wherein the semiconductor substrate has a thickness of greater than about 5 microns.

4. The method of claim 1 wherein the semiconductor substrate comprises a doped silicon material.

5. A method for generating an electrical output signal in response to an incident electromagnetic radiation input signal comprising the steps of:
providing a semiconductor substrate comprising an input surface, a first p-n junction and a first depletion region having a variable first depth,
varying the first depth using a first bias voltage during a first time sample,
sensing a first time sample output signal from the first p-n junction in response to an incident electromagnetic radiation input signal on the input surface,
varying the first depth to a second depth using a second bias voltage during a second time sample,
sensing a second time sample output signal from the first p-n junction in response to an incident electromagnetic radiation input signal on the input surface,
determining a difference between the first time sample output signal and the second time sample output signal, and,
outputting the difference between the first time sample output signal and the second time sample output signal as representative of a range of the electromagnetic spectrum.

6. The method of claim 5 wherein the semiconductor substrate has a thickness of less than about 25 microns.

7. The method of claim 5 wherein the semiconductor substrate has a thickness of greater than about 5 microns.

8. The method of claim 5 wherein the semiconductor substrate comprises a doped silicon material.
